(19) United States
(12) Patent Application Publication
(10) Pub. No.: US 2005/0156741 A1
(43) Pub. Date: Jul. 21, 2005

(54) Gas generator, gas bag module and method for the detection thereof

(75) Inventors: Thomas Kapfelsperger, Muhldorf (DE); Johann Seidl, Toging (DE)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Airbag Systems GmbH

(21) Appl. No.: 11/028,086

(22) Filed: Jan. 3, 2005

(30) Foreign Application Priority Data
Jan. 20, 2004 (DE) 10 2004 002 881.8

(51) Int. Cl. G08B 13/14

(52) U.S. Cl. 340/572.6; 340/825.49; 340/539.32

(57) ABSTRACT

A gas generator or a gas bag module for a vehicle safety system has a signal emitter which is able to be stimulated by an electromagnetic exciter field applied from the exterior or by a magnetic field impulse applied from the exterior, for the emission of a signal. Such signal is detected by means of a manually movable detector (30).

### TECHNICAL FIELD

The invention relates to a gas generator for a vehicle safety system, in particular an occupant restraint system, and to a gas bag module.

### BACKGROUND OF THE INVENTION

Gas generators housed in the vehicle in a concealed manner activate belt tensioners, knee restraint systems, gas bags and the like. In an accident, all the gas generators or all the stages of a multi-stage gas generator are not necessarily ignited. Rescue teams who are rescuing an accident victim from the vehicle could possibly forget, owing to the pressure of time caused by the rescue, that gas generators which are not yet activated are also housed in the vehicle. Particular sites on the vehicle in which the gas generators are housed in a concealed manner, should not be opened by force with side cutters, parting-off grinders or cutting torches. In addition to this there is the fact that the position of the gas generators can differ from one vehicle to the next (variety of models, differences in equipment), which makes it difficult for less experienced rescuers to locate the sites which are not suitable for opening the vehicle. For this reason, one has started thinking about deactivating those gas generators or gas generator stages by ignition which have not been ignited after a predetermined time, if necessary even after previous determining of the position of the occupant.

The invention provides a further possibility of preventing an unintended triggering of the gas generator by inexpert action from the exterior during rescues.

### BRIEF SUMMARY OF THE INVENTION

A gas generator or a gas bag module for a vehicle safety system has a signal emitter which is able to be stimulated by an electromagnetic exciter field applied from the exterior or by a magnetic field impulse applied from the exterior, for an emission of a signal. Such signal is detected by means of a manually movable detector. Gas generators are always built in so as to be concealed. By means of a mobile apparatus which generates an electromagnetic exciter field or a magnetic field impulse, the signal emitter provided on or in the gas generator or in the module can be located, because it is stimulated for the emission of a signal, more precisely an oscillation. The gas generator proposed or the module proposed also offers advantages for the recycling of the vehicle, because the gas generator can be located very precisely.

Preferably the signal is an electromagnetic signal which the signal emitter can emit.

In particular, the signal emitter is a transmitter.

An embodiment makes provision that the signal emitter has an amorphous metal part, usually constructed as a metal strip. Such metals are used in particular for shielding and as magnet cores.

Another embodiment makes provision to construct the signal emitter as a harmonic or acoustomagnetic system. A harmonic system means that the signal emitter responds to the electromagnetic fields of the exciter with harmonic vibrations. Corresponding signal emitters can be formed for example by an amorphous metal band 3 to 10 cm long, 1 to 2 mm wide and 0.02 mm thin. Shorter strips with permanent magnetic characteristics are arranged on this metal band.

Acoustomagnetic systems are particularly favorably priced; they consist for example of a small plastic box which is, for example, approximately 40 mm long, 4 to 14 mm wide depending on construction and approximately 1 mm high. They house an amorphous metal strip approximately 6 mm wide, which is mounted so as to be freely movable and serves as a resonator. On the base of the plastic box, a thin, magnetically hard strip is arranged, which is magnetized in the activated state, but which can be demagnetized for deactivation. The amorphous strip can be stimulated to oscillation by external field action, in fact by a magnetic field impulse in the ultrasonic range. This impulse is alternately switched on and off again. The amorphous strip begins to oscillate and also performs post-pulse oscillations in the toggle-free periods. In acoustomagnetic systems, a toggling ability of the signal emitter could also be realized very simply, i.e. it could be deactivated when the gas generator has been ignited.

The signal emitter is preferably a separate part arranged or housed for example on the outer housing or in it. Another embodiment, on the other hand, makes provision that a wall section of the gas generator is constructed as a signal emitter or, more generally, that a part which is provided in any case in the gas generator for other purposes is constructed as a signal emitter.

In this connection, for example, a wall section can be magnetized.

Other possibilities for the construction of the signal emitter are radio frequency-, high frequency- or low frequency systems.

According to an embodiment, provision can be made that the gas generator is constructed such that on its activation it deactivates the signal emitter. This can take place for example in that the signal emitter is destroyed owing to the heating of the gas generator on activation. In multi-stage gas generators, it can be advantageous in this respect if one signal emitter is associated with each individual stage, so that also a gas generator is detected which was partially activated.

The invention also describes a method of detecting a gas bag module or a gas generator in a vehicle. This method makes provision that a manually movable detector is moved over a vehicle part, which detector transmits a magnetic or, more specifically, an electromagnetic field or a magnetic field impulse and which detects signals, generated thereby, of a signal emitter incorporated in the gas generator or gas bag module.

### BRIEF DESCRIPTION OF THE DRAWINGS

FIG. 1 shows a longitudinal sectional view through a gas bag module according to the invention with a gas generator according to the invention, and

FIGS. 2 and 3 show views of signal emitters provided in the gas generator according to the invention.

### DETAILED DESCRIPTION OF THE PREFERRED EMBODIMENT

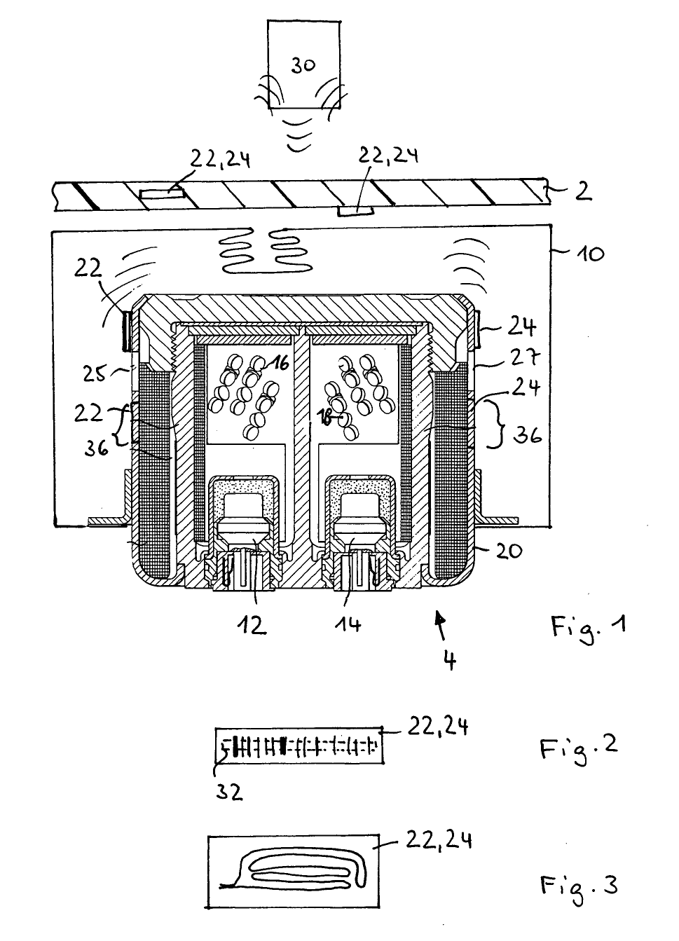

In FIG. 1 a gas bag module is illustrated with a module covering 2, a gas generator 4 and a gas bag 10.

The gas generator 4 is constructed as a two-stage gas generator and has two igniters 12, 14 which are able to be activated separately from each other and which each have one pyrotechnic charge 16, 18 associated thereto. On activation of the corresponding igniter 12, 14, the charge 16 or 18 is ignited and the resulting hot gas flows out from the outer housing 20 of the gas generator and inflates the gas bag 10.

Arranged on the outer housing 20 in the region of outflow openings 25, 27 is in each case a signal emitter 22, 24 which is put in place from the exterior. These signal emitters 22, 24 may have an amorphous metal part, may be constructed as a harmonic or acoustomagnetic system or may be stimulated to emit an electro-magnetic signal in response to radio frequency-, high frequency- or low frequency emission. A manual detector 30 serves as the stimulation source, which by rescue services is moved e.g. along a roof frame, stimulates the signal emitters 22, 24 owing to electromagnetic exciter fields or magnetic field impulses, and which also detects the signals emitted by the signal emitters 22, 24.

The signal emitters 22, 24 may be constructed, for example, as in FIG. 2, namely as barcode adhesive strips behind which an amorphous metal strip 32 is provided.

Through the heating after ignition of the corresponding stages, the signal emitter 22, 24 is deactivated. Alternatively, of course, a loop of soft magnetic material (e.g. of iron/nickel alloys), able to be stimulated by radio frequency signals, can be used, which melts at one site owing to the developing heat, so that the circuit is interrupted. This is illustrated in FIG. 3 as an alternative.

The signal emitter 22, 24 does not necessarily have to be provided on the gas generator 4; it can also be positioned on other parts of the module, for example on the underside or in the covering cap 2, on a metal reinforcement inlay of the cap or can be a portion of such inlay.

As an alternative to the construction of the signal emitter 22, 24 as a prefabricated individual part which is arranged at any location on the gas generator 4/the module, a wall section of the gas generator/module which already exists, e.g. the wall section 36, can be magnetized and hence serve as an integrated signal emitter 22, 24.

It is to be emphasized that any feature of the emitter described in the introductory portion of this specification, in the description of the preferred embodiments, in the claims and in the drawings can be used both for the gas generator and the module.

1. A gas generator for a vehicle safety system, in particular an occupant restraint system,
said gas generator comprising a signal emitter (22, 24) able to be stimulated by one of an electromagnetic exciter field applied from the exterior and a magnetic field impulse applied from the exterior, for emission of a signal.

2. The gas generator according to claim 1, wherein said signal emitter is constructed such that it emits an electromagnetic signal.

3. The gas generator according to claim 1, wherein said signal emitter (22, 24) has an amorphous metal part (32).

4. The gas generator according to claim 1, wherein said signal emitter (22, 24) is one of a harmonic and acoustomagnetic system.

5. The gas generator according to claim 1, wherein said signal emitter (22, 24) can be set in oscillation as a result of an external radio frequency stimulation, in order to emit said signal.

6. The gas generator according to claim 1, wherein said signal emitter (22, 24) is a separate part.

7. The gas generator according to claim 1, wherein said signal emitter (22, 24) is arranged on an outer housing (20) of said gas generator (4).

8. The gas generator according to claim 1, wherein a wall section (36) of said gas generator (4) is constructed as a signal emitter (22, 24).

9. The gas generator according to claim 8, wherein said wall section (36) is magnetized.

10. The gas generator according to claim 1, wherein said signal emitter (22, 24) is constructed such that it is deactivated on activation of said gas generator (4).

11. A gas bag module for a vehicle safety system,
said gas bag module comprising a signal emitter (22, 24) able to be stimulated by one of an electromagnetic exciter field applied from the exterior and a magnetic field impulse applied from the exterior, for an emission of a signal.

12. The gas bag module according to claim 11, including a covering (2) which is provided with said signal emitter (22, 24).

13. The gas bag module according to claim 11, wherein said signal emitter is constructed such that it emits an electromagnetic signal.

14. The gas bag module according to claim 11, wherein said signal emitter (22, 24) has an amorphous metal part (32).

15. The gas bag module according to claim 14, wherein said signal emitter (22, 24) is one of a harmonic and acoustomagnetic system.

16. The gas bag module according to claim 11, wherein said signal emitter (22, 24) can be set in oscillation as a result of an external radio frequency stimulation, in order to emit said signal.

17. The gas bag module according to claim 11, wherein said signal emitter (22, 24) is a separate part.

18. A method of detecting one of a gas bag module and a gas generator (4) in a vehicle, wherein a manually movable detector (30) is moved over a vehicle part, which detector emits one of a magnetic exciter field, an electromagnetic exciter field and a magnetic field impulse and which detects signals of a signal emitter (22, 24) incorporated in one of said gas generator and said gas bag module, which signals are generated by one of said exciter fields and said field impulse.
